(19) United States
(12) Patent Application Publication
(10) Pub. No.: US 2026/0244685 A1
(43) Pub. Date: Aug. 20, 2026

(54) SYSTEMS AND METHODS FOR RELATIONAL NODE-BASED GRAPH DATABASE

(71) Applicant: ID.me, LLC, McLean, VA (US)

(72) Inventors: Scott MEYER, Berkeley, CA (US); Hal HILDEBRAND, Moss Beach, CA (US)

(73) Assignee: ID.me, LLC, McLean, VA (US)

(21) Appl. No.: 19/053,761

(22) Filed: Feb. 14, 2025

(51) Int. Cl. G06F 16/901

(52) U.S. Cl. CPC G06F 16/9024

(57) ABSTRACT

A method, performed by one or more processors, for generating a database, includes: generating a first primary key in a node table for a first entity; generating a second primary key in the node table for a first attribute associated with the first entity; generating a third primary key in the node table for first data associated with the first attribute of the first entity; storing the first data in an attribute table, using the first primary key for the first entity in the node table as a primary key for the first data in the attribute table; and generating a triple with the first primary key as a subject, the second primary key as a predicate, and the third primary key as an object.

### TECHNICAL FIELD

Various embodiments of the present disclosure relate generally to systems and methods for a graph database, and more particularly, to systems and methods for generating a graph database with a shared primary key.

### BACKGROUND

Graph databases are structured for queries using nodes, edges, and properties to represent and store data. A graph database relates the data as a collection of nodes and edges, where the edges represent relationships between the nodes.

However, as the number of properties associated with an edge increases, traversing the properties column of the edge becomes increasingly difficult. Additionally, indexing properties stored in a single column of the edge table makes the properties difficult to index and search. Limiting the number of properties stored in an edge results in redundant nodes and edges that obscure simple relationships between nodes.

The present disclosure is directed to overcoming one or more of these above-referenced challenges.

### SUMMARY OF THE DISCLOSURE

In some aspects, the techniques described herein relate to a method, performed by one or more processors, for generating a database, the method including: generating a first primary key in a node table for a first entity; generating a second primary key in the node table for a first attribute associated with the first entity; generating a third primary key in the node table for first data associated with the first attribute of the first entity; storing the first data in an attribute table, using the first primary key for the first entity in the node table as a primary key for the first data in the attribute table; and generating a triple with the first primary key as a subject, the second primary key as a predicate, and the third primary key as an object.

In some aspects, the techniques described herein relate to a method, further including: generating a fourth primary key for a second attribute associated with the first entity, wherein the second attribute is different from the first attribute.

In some aspects, the techniques described herein relate to a method, further including: storing the first primary key, the second primary key, and the third primary key, in a single subgraph of the database.

In some aspects, the techniques described herein relate to a method, further including: storing the triple in a subgraph of the database.

In some aspects, the techniques described herein relate to a method, further including: authenticating an identity of the first entity using the triple.

In some aspects, the techniques described herein relate to a method, further including: generating a confidence level for the first data of the first attribute associated with the first entity.

In some aspects, the techniques described herein relate to a method, further including: exporting the triple to an external data structure.

In some aspects, the techniques described herein relate to a system including: one or more data storage devices that store instructions for generating a database; and one or more processors configured to execute the instructions to perform a method including: generating a first primary key in a node table for a first entity; generating a second primary key in the node table for a first attribute associated with the first entity; generating a third primary key in the node table for first data associated with the first attribute of the first entity; storing the first data in an attribute table, using the first primary key for the first entity in the node table as a primary key for the first data in the attribute table; and generating a triple with the first primary key as a subject, the second primary key as a predicate, and the third primary key as an object.

In some aspects, the techniques described herein relate to a system, wherein the method further includes: generating a fourth primary key for a second attribute associated with the first entity, wherein the second attribute is different from the first attribute.

In some aspects, the techniques described herein relate to a system, wherein the method further includes: storing the first primary key, the second primary key, and the third primary key, in a single subgraph of the database.

In some aspects, the techniques described herein relate to a system, wherein the method further includes: storing in separate subgraphs the triple of the first primary key, the second primary key, and the third primary key.

In some aspects, the techniques described herein relate to a system, wherein the method further includes: authenticating an identity of the first entity using the triple.

In some aspects, the techniques described herein relate to a system, wherein the method further includes: generating a confidence level for the first data of the first attribute associated with the first entity.

In some aspects, the techniques described herein relate to a system, wherein the method further includes: exporting the triple to an external data structure.

In some aspects, the techniques described herein relate to a database including: a first node for a first entity, wherein the first node includes a first primary key for the first entity; a second node for a first attribute associated with the first entity, wherein the second node includes the first primary key for the first entity and first data associated with the first attribute, and wherein the first attribute is associated with a second primary key and the first data is associated with a third primary key; and a first edge defined by the first primary key as a subject, the second primary key as a predicate, and the third primary key as an object.

In some aspects, the techniques described herein relate to a database, wherein the first node and the second node are stored in a first subgraph of the database.

In some aspects, the techniques described herein relate to a database, wherein an association between the first node and the first entity are stored in a second subgraph of the database.

In some aspects, the techniques described herein relate to a database, wherein the database further includes: a third node for a second entity, wherein the third node includes a fourth primary key for the second entity; a fourth node for a second attribute associated with the second entity, wherein the fourth node includes the fourth primary key for the second entity and second data associated with the second attribute, and wherein the second attribute is associated with a fifth primary key and the second data is associated with a sixth primary key; and a second edge defined by the fourth primary key as a subject, the fifth primary key as a predicate, and the sixth primary key as an object.

In some aspects, the techniques described herein relate to a database, wherein the database further includes: the first edge and the second edge stored in a subgraph of the database.

In some aspects, the techniques described herein relate to a database, wherein the first data is constrained in the database.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment 100 that may be utilized with techniques presented herein, according to one or more embodiments.

FIG. 2A, FIG. 2B, FIG. 2C, FIG. 2D, FIG. 2E, and FIG. 2F depict exemplary tables in a graph database, according to one or more embodiments.

FIG. 3 depicts an exemplary provenance table in a graph database, according to one or more embodiments.

FIG. 4A and FIG. 4B depict exemplary attributes associated with a single domain in a graph database, according to one or more embodiments.

FIG. 5A and FIG. 5B depict exemplary relationships and tables in a graph database, according to one or more embodiments.

FIG. 6 depicts a controller for executing the methods and processes described herein, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value. In this disclosure, unless stated otherwise, “automatically” is used to indicate that an operation is performed without user input or intervention.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for a graph database, and more particularly, to systems and methods for generating a graph database with a shared primary key. One or more embodiments may store properties or attributes of edges as additional nodes that are themselves connected via edges to other nodes.

In a graph database, edges allow data to be linked together and retrieved in one operation. Nodes may be any type of information, including, but not limited to, entities, people, places, identities, passwords, or other types of identifying information. Edges connect two nodes together either uni-directionally or bi-directionally. A uni-directional edge represents a “from” node and “to” node, whereas a bi-directional edge has no such significance. Graph databases may store properties on the edges associated with the two nodes. Edges may be stored as a tuple in the form of {node 1, relationship, node 2}.

Additional information stored by the source regarding the entity may be stored as a property of the edge, thereby providing additional information apart from the edge. Typically, most properties of an edge are stored as a single column of the edge table, giving the edge table the form of {node 1, relationship, node 2, properties}.

For instance, one node may represent an attribute, and one node may represent an entity that stores that attribute. Linking the entity node and the attribute node using an edge, the graph database may store and represent that the source of the attribute is the entity. Graph databases, thus, present a natural way of modeling relationships between information.

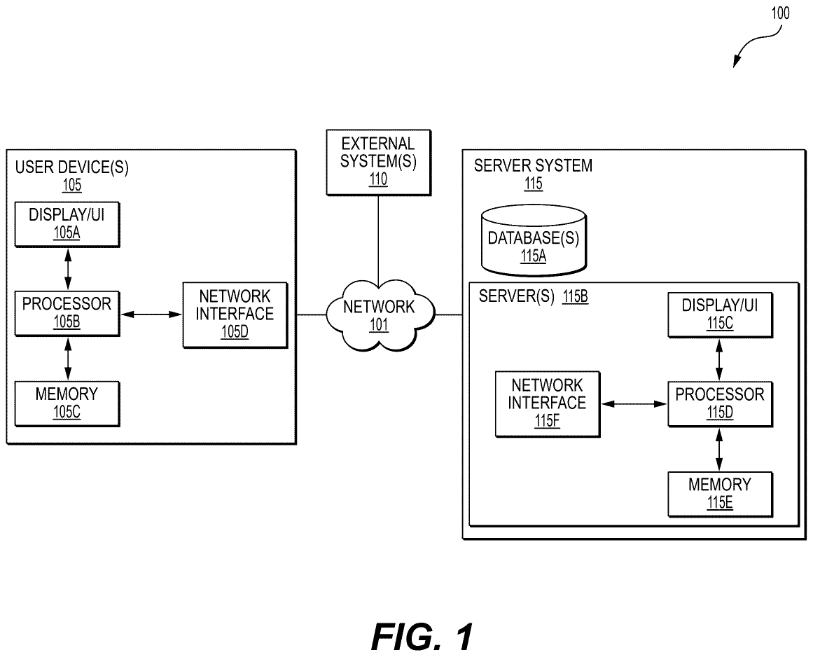

FIG. 1 depicts an exemplary environment 100 that may be utilized with techniques presented herein, according to one or more embodiments. A user device 105, one or more external system(s) 110, and one or more server system(s) 115 may communicate across a network 101. As will be discussed in further detail below, one or more server system(s) 115 may communicate with one or more of the other components of the environment 100 across network 101. The user device 105 may be associated with one or more users and/or user accounts.

The components of the environment 100 may be associated with a common entity. One or more components of the environment 100 may be associated with a different entity. The systems and devices of the environment 100 may communicate in any arrangement.

The user device 105 may be configured to enable the user to access and/or interact with other systems in the environment 100. For example, the user device 105 may be a computer system such as, for example, a desktop computer, a mobile device, a tablet, etc. The user device 105 may include one or more electronic application(s), e.g., a program, plugin, browser extension, etc., installed on a memory 105C of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (e.g., a browser program in a mobile O/S), an applicant specific program, system control software, system monitoring software, software development tools, or the like. The electronic application(s) may be associated with one or more of the other components in the environment 100. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system(s) 115, and may perform one or more operations prior to providing an output to the network 101.

External systems 110 may be, for example, one or more third party and/or auxiliary systems that integrate and/or communicate with the server system(s) 115. For example, external systems 110 may include one or more cloud-computing platforms and/or services utilized by user device 105 and/or server system(s) 115 to host the application asset(s). External systems 110 may be in communication with other device(s) or system(s) in the environment 100 over the one or more networks 101. For example, external systems 110 may communicate with the server system(s) 115 via API (application programming interface) access over the one or more networks 101, and communicate with the user device 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system(s) 115 may include an electronic data system, e.g., a computer-readable memory such as a hard drive, flash drive, disk, etc. In some embodiments, the server system(s) 115 includes and/or interacts with an application programming interface for exchanging data to other systems, e.g., one or more of the other components of the environment.

The server system(s) 115 may include a database 115A and at least one server 115B. The server system(s) 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system(s) 115 may execute, by the processor 115D, an operating system (O/S) and at least one instance of a servlet program (each stored in memory 115E).

Database 115A may be any system or software that provides a user the ability to enter, store, retrieve, and/or manage data. Database 115A may be a relational database that presents data to users as relationships linking a domain and an attribute. The domain may be any entity or person, and the attribute may be any property of the domain. Database 115A may assign a unique primary key for each domain. Database 115A may assign a unique primary key for each attribute and/or any data associated with that attribute. Every primary key may be any natural number (e.g., 1, 2, 3, 4), for example.

Database 115A may store every domain, attribute, and data associated with an attribute as a node, and identify each node via a primary key. Database 115A may store all generated primary keys in a primary table. Database 115A may store all the data associated with each primary key, with each primary key treated as a domain.

Each node may have a relationship, association, or connection with one or more nodes in database 115A. The relationship, association, or connection may be referred to as an edge. The edge may be assigned a primary key that is stored in database 115A. Database 115A may store any edge between one or more nodes in a subgraph as well. The subgraph may store an edge using only primary keys, with the data associated with each primary key accessible in a different subgraph. The edge may store the relationship between nodes in a triple, identifying one node as the subject, or the domain, the second node as the predicate, or the attribute, and the third node as the object, or the data associated with that attribute, where each node is identified only by a primary key. Database 115A may export the triple to an external data structure. Storing an edge in this way may allow a user to quickly determine information regarding the subject.

Database 115A may store the source, or provenance, of any data that is associated with a domain. The provenance may be assigned a primary key. Database 115A may generate a node representing a confirmed, or resolved, attribute for an entity with regard to a source of the attribute. Doing so may allow database 115A to join the core data associated with an attribute and the source of that data attribute. The resolved node may be assigned a primary key. Database 115A may store, in a subgraph, the association between the attribute data and the source of that data, referring only to the primary key assigned to the resolve node. Utilizing the resolved node may allow database 115A to refer to the primary key of the entity itself as opposed to a compound key that includes the data associated with an entity and the source of the data.

Using the resolved node, database 115A may store all attributes associated with a resolved node using only primary keys. All of the attributes themselves and their associated data are stored in subgraphs. Organizing database 115A in this way may allow for binding together the fundamental identity of an entity, an attribute associated with that person, and the source of that attribute. Database 115A may store a confidence level that describes the level of confidence in the relationship between the entity and an attribute based on the source, giving a higher confidence level when the attribute is considered to be more accurate or provided by a highly trusted source, and a lower confidence level when the attribute is considered less accurate or provided by a less trusted source. Database 115A may be used for any purpose, such as to authenticate the identity of an entity or person stored as a domain and/or an attribute associated with the domain.

Although depicted as separate components in FIG. 1, it should be understood that a component or portion of a component in the environment 100 may, in some embodiments, be integrated with or incorporated into one or more other components. For example, a portion of the display/UI 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

In general, any process or operation discussed in this disclosure that is understood to be computer-implementable, such as the processes illustrated, may be performed by one or more processors of a computer system, such any of the systems or devices in the environment 100 of FIG. 1, as described above. A process or process step performed by one or more processors may be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

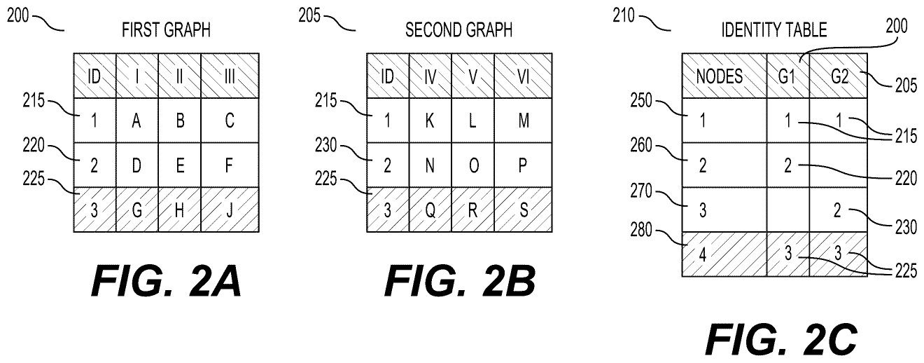

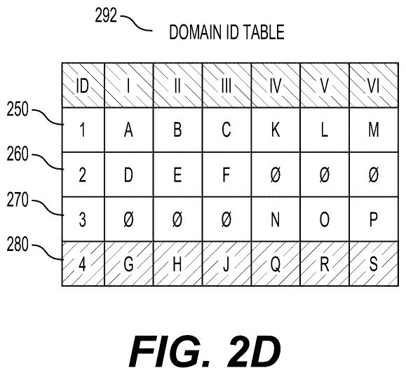

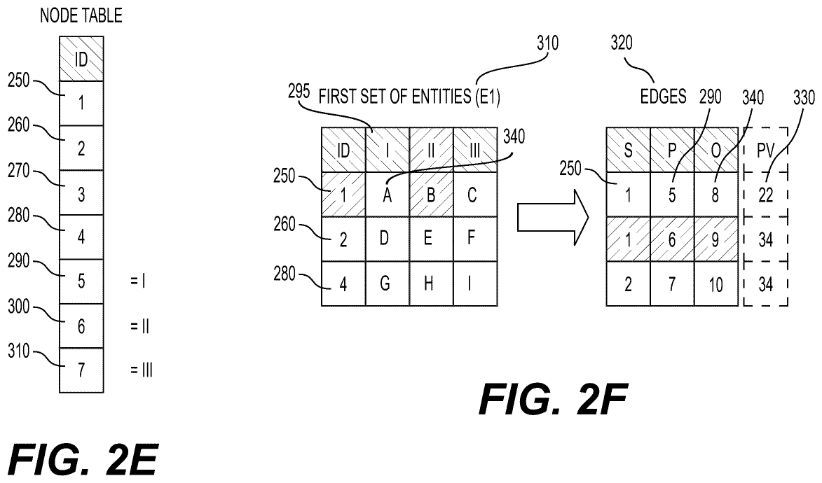

FIG. 2A, FIG. 2B, FIG. 2C, FIG. 2D, FIG. 2E, and FIG. 2F depict exemplary tables in a graph database, according to one or more embodiments. FIG. 2A depicts first graph 200. First graph 200 may include columns, defining attribute I, attribute II, and attribute III, and rows, defining domain 215, domain 220, and domain 225. Each domain may be an entity, or a person, for example. The attribute may be any property associated with the domain. Each domain may be assigned a primary key (in this case an ID number) in first graph 200. The ID number may be any natural number. Domain 215, domain 220, and domain 225 may be associated with attribute I, attribute Il, and attribute III. Letters A-J may be the data associated with each of attribute I, attribute II, and attribute III corresponding to domain 215, domain 220, and domain 225, respectively. By way of non-limiting example, domain 215 may be assigned primary key number 1, and may be associated with attribute I, attribute II, and attribute III which correspond to the name, address, and telephone number of domain 215.

FIG. 2B depicts second graph 205. Second graph 205 may include columns, defining attribute IV, attribute V, and attribute VI, and rows, defining domain 215, domain 230, and domain 225. Each domain may be an entity, or a person, for example. The attributes in second graph 205 may be any property associated with the domain, and may be different from those in first graph 200. Each domain may be assigned a primary key (in this case an ID number) in second graph 205. The ID number may be any natural number. Domain 215, domain 220, and domain 225 may be associated with attribute I, attribute II, and attribute III. Letters K-S may be the data associated with each of attribute IV, attribute V, and attribute VI corresponding to domain 215, domain 230, and domain 225, respectively. By way of non-limiting example, domain 215 may be assigned primary key number 1, and may be associated with attribute IV, attribute V, and attribute VI which correspond to the date of birth, driver license number, and social security number of domain 215.

FIG. 2C depicts an identity table 210. Identity table 210 may be generated to associate domains that appear in both first graph 200 and second graph 205. Identity table 210 assigns each domain from first graph 200 and second graph 205 a new primary key, referred to as a node, assigning the same node to any pair of domains that appear in both graphs. For domains that are unique to either first graph 200 or second graph 205, in this case domain 220 and domain 230, identity table 210 assigns unique nodes. A node may be any natural number.

Identity table 210 tracks the assignment of nodes to each domain. The column labelled G1 may correspond to the ID numbers assigned to the domains in first graph 200. The column labelled G2 may correspond to the ID numbers assigned to the domain in the second graph 205. Because ID number 1 in first graph 200 and ID number 1 in second graph 205 represent the same domain 215, ID number 1 in first graph 200 and ID number 1 in second graph 205 may be assigned node 250, represented by the integer 1, in identity table 210.

Similarly, because ID number 3 in first graph 200 and ID number 3 in second graph 205 represent the domain 225, identity table 210 assigns node 280, represented by the integer 4. Domain 220 and domain 230, which may be represented by ID number 2 in both first graph 200 and second graph 205, are different domains. For this reason, in identity table 210, domain 220 and domain 230 may be assigned different nodes. For instance, domain 220 may be assigned node 260, represented by the integer 2. Domain 230 may be assigned node 270, represented by integer 4. In this way, identity table 210 may associate various domains for which data has been received from different intermediaries or sources.

FIG. 2D depicts domain ID table 292. Domain ID table 292 may be generated by joining first graph 200 and second graph 205 using the nodes generated by the identity table 210. Each of node 250, node 260, node 270, and node 280 may be present in domain ID table 292. Utilizing the nodes generated in identity table 210 enables joining first graph 200 with second graph 205, and combining the attributes associated with each domain into a single table. For instance, domain 215, represented by node 250, may be stored in domain ID table 292 in association with all attributes I through VI and their associated data (e.g. A, B, C, K, L, and M). Domain 225, represented by node 280, may be stored in domain ID table 292 with all attributes I through VI and their associated data (e.g. G, H, J, Q, R, and S).

Separately, node 260, representing domain 220, and node 270, representing domain 230, appear only in first graph 200 and second graph 205, respectively. As a result, node 260 is only associated with attribute I, attribute II, and attribute III while node 270 is only associated with attributes corresponding to attribute IV, attribute V, and attribute IV. In order to rectify this issue, domain ID table 292 may contain null values for cells representing attributes which do not contain data associated with node 260 or node 270. In this instance, the null values for node 260 may be placed in cells corresponding to attribute IV, attribute V, and attribute VI while null values for node 270 may be placed in cells corresponding to attribute I, attribute II, and attribute III.

As depicted in FIG. 2E, nodes may be generated to represent domains, attributes, and data associated with an attribute. For instance, as depicted in FIG. 2E, attribute I, attribute II, and attribute III may be assigned node 290, node 300, and node 310 represented by ID numbers 5, 6, and 7, respectively. Domain 215 may be assigned node 250, represented by integer 1, and the data associated with attribute 295 for domain 215 being assigned node 340, represented by integer number 8 (which is not shown in the node table of FIG. 2E). The information associated with node 250, node 290, and node 300 may be stored in subgraphs associating each node with the information that they represent.

Assigning primary keys to an entity, attribute, and data allows for generating an edge table 320, and preserving connections between the nodes using only shared primary keys. For instance, associating domain 215 with attribute I having data A, can be represented in edge table 320 with node 250 as the subject, attribute I as the predicate with node 290 and associated data as the object with node 300. In this way, edge table 320 may store the relationship between the entity, attribute, and data represented by integers 1, 5, and 8 without requiring any additional data. Additional attributes may be stored as nodes in edge table 320. For instance, the provenance of the data associated with an attribute may be assigned node 330, represented by integer 22, and stored as another column in the edge table 320.

By storing data using only primary keys across the database 115A without relying on the data itself, the entire database 115A need not rely on an equivalence table connecting common entities out of different tables. Storage of relationships between nodes using just primary keys may allow for simplification of database 115A, thereby reducing the need for additional nodes or edges. Use of primary keys alone may simplify the inbound and outbound relationships between nodes of an edge. By assigning primary keys to attributes and their associated data, sub-graphs may be defined that constrain the attributes and data, and limiting the domains that can be used with the node. In this way, database 115A may be simplified by requiring the same constraints of all entered data.

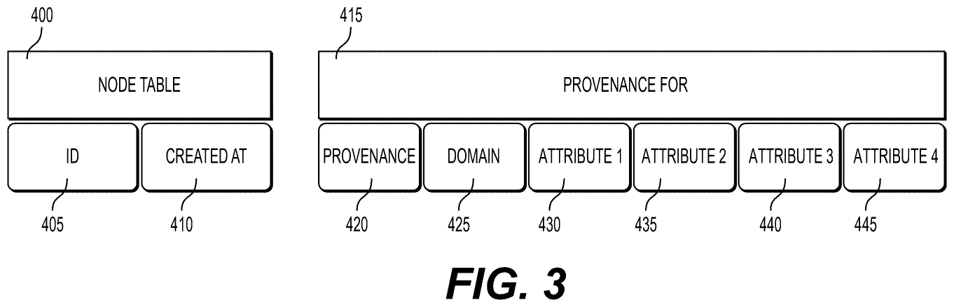

FIG. 3 depicts an exemplary provenance table in a graph database, according to one or more embodiments. FIG. 3 depicts node table 400 and edge table 415. Edge table 415 may associate a domain, its attributes, and the source of those attributes. Edge table 415 has a target node, in this instance domain 425, which has edges linked to various attributes (i.e. attribute 1 (430), attribute 2 (435), attribute 3 (440), and attribute 4 (445)). Edge table 415 may include an inbound node, in this instance, provenance 420. In this model, provenance 420 represents the source of the attributes and associated data related to domain 425.

For each property included in edge table 415 (i.e. provenance 420, domain 425, attribute 1 (430), attribute 2 (435), attribute 3 (440), and attribute 4 (445)), node 405 is generated with a timestamp 410 and stored in node table 400. Additional nodes are generated for the provenance and attributes, none of which are shown in node table 400. In the model described herein, each of the actual properties may be substituted in table 415 for their assigned node, such that table 415 becomes a table of nodes, represented by natural numbers. The properties associated with those nodes may then be stored in subgraphs, each of which may be identified by the integer assigned to each node.

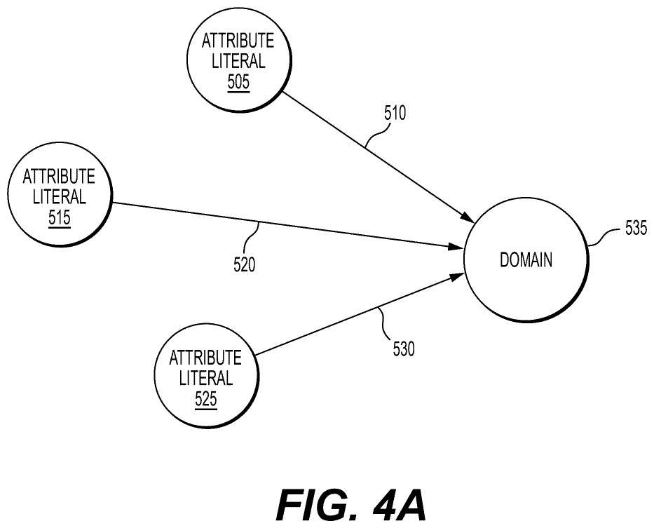

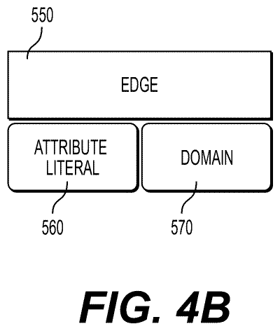

FIG. 4A and FIG. 4B depict exemplary attributes associated with a single domain in a graph database, according to one or more embodiments. Attribute literal 505, attribute literal 515, and attribute literal 525 are independent nodes that are associated with domain 535. The relationship between each of attribute literal 505, attribute literal 515, and attribute literal 525 may be associated with domain 535 via edge 510, edge 520, and edge 530, respectively. Each of attribute literal 505, attribute literal 515, attribute literal 525, and domain 535 are assigned a node, represented by an ID number. The data associated with each node is then stored in a subgraph. Each of edge 510, edge 520, and edge 530 are then represented in the database using only nodes, represented by ID numbers. FIG. 4B is one such edge 550 storing the association between an attribute literal 560 and a domain 570.

By storing edges in a table using only nodes, database 115A may constrain the data that may be associated with each attribute within the subgraphs. Moreover, for the same reason, database 115A constrains the target node, in this instance domain 535, to only point to the nodes associated with the appropriate attributes. Edge 510, edge 520, and edge 530 may be uni-directional or bi-directional.

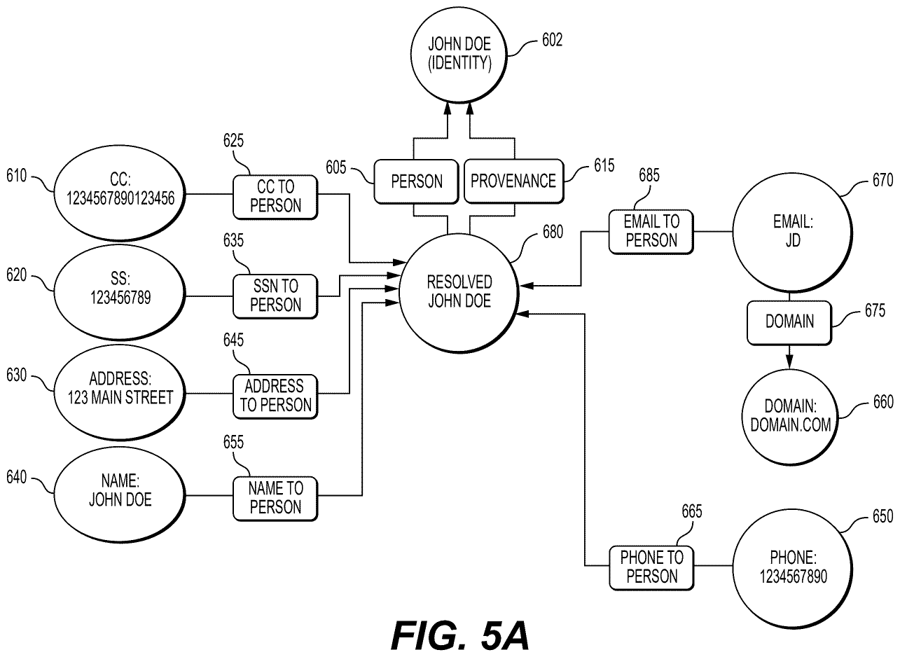

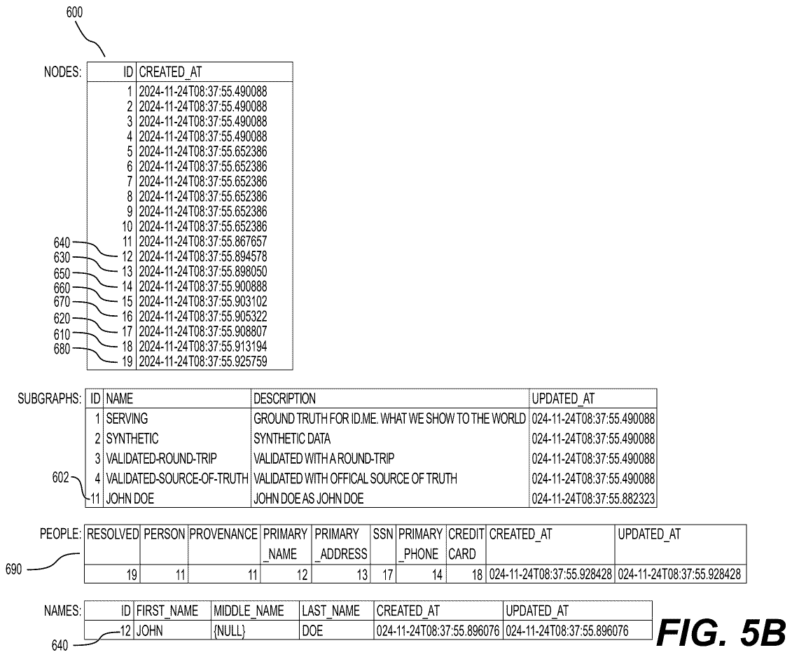

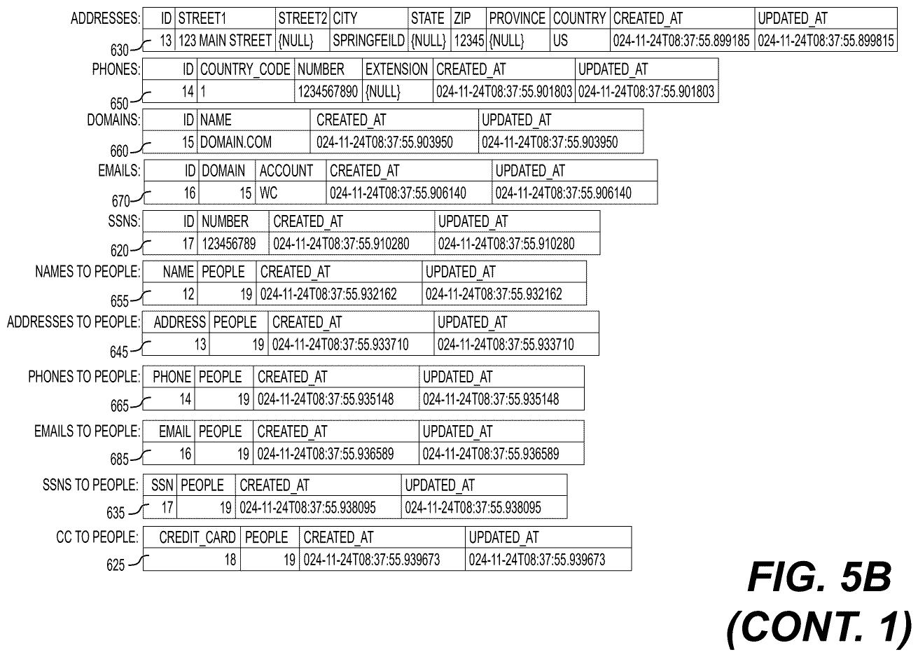

FIG. 5A and FIG. 5B depict exemplary relationships and tables in a graph database, according to one or more embodiments. An individual, John Doe, self-reports data associated with a number of attributes to a database 600 where all of the provided information is stored. Database 600 generates a node 602 identifying John Does as the identity of the individual, assigning it ID number 11. Database 600 generates an additional node 680 identifying John Doe as the verified, or resolved, individual, assigning it ID number 19. All edges extend to other nodes defining attributes of the individual John Doe from node 680. Edge 605, labelled person, and edge 615, labelled provenance, signify that the source of the resolved identity is the person, John Doe, himself. Database 600 may store these edges using only node 680 and node 602.

All attributes and their associated data are stored in the database as nodes as well. For instance, the credit card number associated with the individual John Doe is stored as node 610, given ID number 18. The data associated with node 610 is stored in a subgraph. Edge 625 is stored by the database associating the credit card number with the resolved identity, node 680. The social security number associated with individual John Doe is stored as node 620, given ID number 17. The data associated with node 620 is stored in a subgraph. Edge 635 is stored by the database associating the social security number with the resolved identity, node 680. The address associated with individual John Doe is stored as node 630, given ID number 13. The data associated with node 630 is stored in a subgraph. Edge 645 is stored by the database associating the address with the resolved identity, node 680. The name associated with individual John Doe is stored as node 640, given ID number 12. The data associated with node 640 is stored in a subgraph. Edge 655 is stored by the database associating the name with the resolved identity, node 680. The phone number associated with individual John Doe is stored as node 650, given ID number 14. The data associated with node 650 is stored in a subgraph. Edge 665 is stored by the database associating the telephone number with the resolved identity, node 680. The email associated with individual John Doe is stored as node 670, given ID number 16. The data associated with node 670 is stored in a subgraph. Edge 685 is stored by the database associating the email with the resolved identity, node 680. The domain for the email is stored separately as node 660, given ID number 15. Edge 675 is stored by the database associating email, node 670, with the domain, node 660.

All nodes generated by the database are stored in the node table by their assigned ID numbers in FIG. 5B. The data associated with those nodes are then stored in subgraph utilizing each of the nodes ID numbers. The edges associating data stored by the graph and the resolved identity are stored by the database via the nodes, utilizing the numbers associated with those nodes. The database may store the resolved identity, the source of the resolved identity, and all associated attributes as a single edge 690 using just nodes, represented by ID numbers. For instance, single edge 690 stores the resolved identity, the actual identity and source, the name, address, social security number, phone number, and credit card number using just nodes, represented by ID numbers.

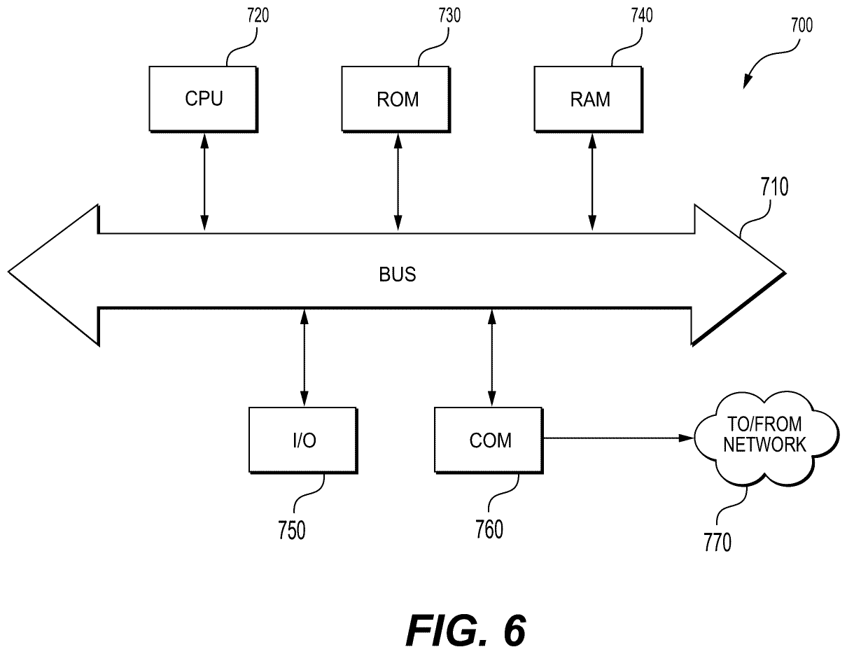

FIG. 6 depicts a controller for executing the methods and processes described herein, according to one or more embodiments. For example, device 700 may include a central processing unit (CPU) 720. CPU 720 may be any type of processor device including, for example, any type of special purpose or a general-purpose microprocessor device. As will be appreciated by persons skilled in the relevant art, CPU 720 may be a single processor in a multi-core/multiprocessor system, such system operating alone, or in a cluster of computing devices operating in a cluster or server farm. CPU 720 may be connected to a data communication infrastructure 710, for example, a bus, message queue, network, or multi-core message-passing scheme.

Device 700 may include a main memory 740, for example, random access memory (RAM), and may include a secondary memory 730. Secondary memory 730, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 730 may include other similar means for allowing computer programs or other instructions to be loaded into device 700. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 700.

Device 700 may include a communications interface (“COM”) 760. Communications interface 760 allows software and data to be transferred between device 700 and external devices. Communications interface 760 may include a modem, a network interface (such as an Ethernet card), a communications port, a PCMCIA slot and card, or the like. Software and data transferred via communications interface 760 may be in the form of signals, which may be electronic, electromagnetic, optical, or other signals capable of being received by communications interface 760. These signals may be provided to communications interface 760 via a communications path 770 of device 700, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 700 may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the general description and the detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A method, performed by one or more processors, for generating a database, the method comprising:
generating a first key in a node table having a single column for a first domain, wherein the first domain is included in one or more of a first graph or a second graph;
generating a second key in the node table for a first attribute in a domain table associated with the first domain;
generating a third in the node table for first data associated with the first attribute of the first domain;
storing the first data in an attribute table, using the first key for the first domain in the node table as a primary key for the first data in the attribute table; and
generating a triple with the first key as a subject, the second as a predicate, and the third key as an object.

2. The method of claim 1, further comprising:
generating a fourth key for a second attribute associated with the first domain, wherein the second attribute is different from the first attribute.

3. The method of claim 1, further comprising:
storing the first the second key, and the third in a single subgraph of the database.

4. The method of claim 3, further comprising:
storing the triple in a subgraph of the database.

5. The method of claim 1, further comprising:
authenticating an identity of the first domain using the triple.

6. The method of claim 1, further comprising:
generating a confidence level for the first data of the first attribute associated with the first domain.

7. The method of claim 1, further comprising:
exporting the triple to an external data structure.

8. A system comprising:
one or more data storage devices that store instructions for generating a database; and
one or more processors configured to execute the instructions to perform a method including:
generating a first key in a node table having a single column for a first domain, wherein the first domain is included in one or more of a first graph or a second graph;
generating a second key in the node table for a first attribute in a domain table associated with the first domain;
generating a third key in the node table for first data associated with the first attribute of the first domain;
storing the first data in an attribute table, using the first key for the first domain in the node table as a primary key for the first data in the attribute table; and
generating a triple with the first key as a subject, the second primary key as a predicate, and the third primary key as an object.

9. The system of claim 8, wherein the method further includes:
generating a fourth for a second attribute associated with the first domain, wherein the second attribute is different from the first attribute.

10. The system of claim 8, wherein the method further includes:
storing the first key, the second key, and the third key, in a single subgraph of the database.

11. The system of claim 10, wherein the method further includes:
storing in separate subgraphs the triple of the first key, the second key, and the third key.

12. The system of claim 8, wherein the method further includes:
authenticating an identity of the first domain using the triple.

13. The system of claim 8, wherein the method further includes:
generating a confidence level for the first data of the first attribute associated with the first domain.

14. The system of claim 8, wherein the method further includes:
exporting the triple to an external data structure.

15. A non-transitory computer readable medium including a database comprising:
a first node for a first domain in a node table having a single column, wherein the first node includes a first key for the first domain included in one or more of a first graph or a second graph;
a second node for a first attribute in a domain table, wherein the first attribute is associated with the first domain, wherein the second node includes the first for the first domain and first data associated with the first attribute, and wherein the first attribute is associated with a second key and the first data is associated with a third key; and
a first edge defined by the first key as a subject, the second as a predicate, and the third key as an object.

16. The database of claim 15, wherein the first node and the second node are stored in a first subgraph of the database.

17. The database of claim 16, wherein an association between the first node and the first domain are stored in a second subgraph of the database.

18. The database of claim 15, wherein the database further includes:
a third node for a second domain, wherein the third node includes a fourth key for the second domain;
a fourth node for a second attribute associated with the second domain, wherein the fourth node includes the fourth key for the second domain and second data associated with the second attribute, and wherein the second attribute is associated with a fifth key and the second data is associated with a sixth key; and
a second edge defined by the fourth key as a subject, the fifth key as a predicate, and the sixth key as an object.

19. The database of claim 18, wherein the database further includes:
the first edge and the second edge stored in a subgraph of the database.

20. The database of claim 15, wherein the first data is constrained in the database.
